(19) United States
(12) Patent Application Publication
(10) Pub. No.: US 2003/0075174 A1
(43) Pub. Date: Apr. 24, 2003

(54) Respiratory hoods

(76) Inventor: Daniel Shahaf, Yaakov (IL)

Correspondence Address: BAKER & MCKENZIE, 805 THIRD AVENUE, NEW YORK, NY, 10022, US

(21) Appl. No.: 10/052,968

(22) Filed: Jan. 18, 2002

Related U.S. Application Data
(60) Provisional application No. 60/345,074, filed on Oct. 24, 2001.

(51) Int. Cl. A62B 7/10

(52) U.S. Cl. 128/201.25

(57) ABSTRACT

Respirator having a transparent bag for covering a head of a user and at least one filter for filtering air from outside the bag. The at least one filter is attached to the bag and located away from a line of sight of the user. A band attached to the bag is located around the top of the head.

### CROSS-REFERENCE TO RELATED APPLICATIONS

The present application claims benefit of provisional application No. 60/345,074 filed Oct. 24, 2001.

### FIELD

The present application relates to inhalation protection apparatuses and, more particularly, to respirators that protect users from inhaling contaminated air.

### BACKGROUND OF THE INVENTION

Respirators, also known as gas masks, are an important part of safety. For instance, respirators protect people from flour dust in a grain elevator and damaging organic chemicals in paint spray. Moreover, respirators are useful to counter terrorist acts using chemical weapons and/or biological weapons. Many respirators are tight-fitting plastic or rubber face masks with some sort of filtering cartridge. These masks cover the nose and mouth and are called half-mask air-purifying respirators. Depending on the chemical or biological agents in the environment, a half-mask may not be sufficient because the eyes are very sensitive to chemicals and offer an easy entry point for bacteria. In this case, a full-face respirator is needed, as a full-face respirator provides a clear face mask or clear eye pieces that also protect the eyes. A full-face respirator can also be constructed as a hood placed over a user's head.

Further, a supplied-air respirator can use the same sort of filtering cartridge found in the air-purifying respirators. However, instead of placing the filter directly on the mask and requiring the user's lungs to suck air through it, the filter attaches to a battery-operated canister. The canister uses a fan to force air through the filter, and then the purified air runs through a hose to the mask. The advantage is that the air coming into the mask has positive pressure. Any leak in the mask causes purified air from the canister to escape, rather than allowing contaminated air from the environment to enter. Positive pressure creates a much safer system. Disadvantages, however, include if the batteries run out, the life of the user is in jeopardy and the constant air flow through the filter means that the filter does not last as long. Such masks have been used for infants and children because their small faces make masks difficult to fit reliably.

Another known respirator is a self-contained breathing apparatus (“SCBA”) system, for example, the system a firefighter uses which includes a full-face mask with an air tank on his or her back. The air tank contains high-pressure purified air. The tank provides constant positive pressure to the face mask. An SCBA system provides protection, but the tanks are heavy and bulky, the tanks contain only 30 or 60 minutes of air, the tanks have to be refilled using special equipment, and SCBA systems are expensive.

Filters used with respirators can remove poisonous chemicals and deadly bacteria from the air. A typical disposable filter cartridge for a respirator operates as follows. When a user inhales, air flows through the inlet, through a particulate filter, through an activated charcoal filter, through another particulate filter (to trap charcoal dust) and through an outlet into the mask. When the particulate filter clogs or the activated charcoal becomes saturated, the cartridge needs to be replaced.

An air filter can use one or more of three different techniques to purify air. These techniques include particle filtration, chemical absorption or adsorption and chemical reaction to neutralize a chemical.

Particle filtration is the simplest of the three. In a gas mask designed to guard against a biological threat, a very fine particulate filter can be used. An anthrax bacteria or spore might have a minimum size of one micron. Most biological particulate filters remove particle sizes as small as 0.3 microns. Any particulate filter eventually clogs, so it has to be replaced as breathing becomes difficult.

A chemical threat needs a different approach because chemicals come as mists or vapors that are largely immune to particulate filtration. The most common approach with any organic chemical is activated charcoal which is a carbon. Activated charcoal is charcoal that has been treated with oxygen to open up millions of tiny pores between the carbon atoms. The use of special manufacturing techniques results in highly porous charcoals that have surface areas of 300-2,000 square meters per gram. These activated charcoals are widely used to adsorb odorous or colored substances from gases or liquids. When a material adsorbs something, the material attaches to it by chemical attraction. The large surface area of activated charcoal gives it countless bonding sites. When certain chemicals pass next to the carbon surface, the chemicals attach to the surface and are trapped. Activated charcoal is effective at trapping carbon-based impurities, such as organic chemicals, as well as things like chlorine. Many other chemicals are not attracted to carbon at all, for instance, sodium and nitrates, so these chemicals pass right through. Thus, an activated-charcoal filter will remove certain impurities while ignoring others and once all of the bonding sites are filled, an activated-charcoal filter stops working. At that point, the filter needs to be replaced. Activated charcoal can be treated with other chemicals to improve its adsorption abilities for a specific toxin.

The third technique involves chemical reactions. Masks can contain chemicals designed to react with and neutralize the contaminated air. For instance, chlorine is removed by reaction with sodium thiosulfate and phosgene is removed by reaction with hexamethyltetramine.

As would be appreciated by a person having ordinary skill in the art, filters exist for filtering many types of contaminated air, such as air contaminated by chemical weapons, biological weapons and smoke. As a result, a user does not have to be concerned with the type of filter included in the respirator, as the filter is operable to filter a variety of types of contaminated air.

### SUMMARY OF THE INVENTION

An aspect of the present application provides for an inhalation protection apparatus. The inhalation protection apparatus includes a transparent bag made of a lightweight and flexible material for covering a head of a user, the transparent bag including a lower portion having an opening and an upper portion, at least one filter for filtering air outside the transparent bag, the at least one filter attached to the transparent bag and located away from a line of sight of the user, and a band attached to the upper portion of the transparent bag, the band operable for securing the transparent bag to the top of the head and preventing the transparent bag from rotating around the head of the user after the transparent bag is placed on the head, wherein the opening of the transparent bag can be placed over the head in any manner as a result of the bag being made of a transparent material and the at least one filter being located away from the line of sight of the user.

Another aspect of the present application provides for a respirator. The respirator includes a transparent bag made of a lightweight and flexible material for covering a head of a user, the transparent bag including a lower portion having an opening and an upper portion, at least one filter for filtering contaminated air outside the transparent bag, the at least one filter attached to the transparent bag and located in the lower portion of the transparent bag so that the at least one filter is located away from a line of sight of the user, a band attached to the upper portion of the transparent bag, the band operable for securing the transparent bag to the top of the head by resting on the forehead and preventing the transparent bag from rotating around the head of the user after the transparent bag is placed on the head, and a securing collar attached to the transparent bag, the securing collar operable to tighten the lower portion of the transparent bag around the neck of the user, wherein the bag, the at least one filter, the band and the securing collar are arranged so that the user can be an adult, a child or an animal, and the opening of the transparent bag can be placed over the head in any manner as a result of the bag being made of a transparent material and the at least one filter being located away from the line of sight of the user.

### BRIEF DESCRIPTION OF THE DRAWINGS

FIG. 1a illustrates a side view of an exemplary respirator;

FIG. 1b illustrates a front view of the exemplary respirator shown in FIG. 1a;

FIG. 2a illustrates a side view of the exemplary respirator shown in FIGS. 1a and 1b placed over the head of a user;

FIG. 2b illustrates a front view of the exemplary respirator shown in FIGS. 1a and 1b placed over the head of the user;

FIG. 3 illustrates a side view of the exemplary respirator shown in FIGS. 1a and 1b placed over the head of another user;

FIG. 4 illustrates a front view of the exemplary respirator shown in FIGS. 1a and 1b placed over the head of a child;

FIG. 5 illustrates a side view of the exemplary respirator shown in FIGS. 1a and 1b placed over the head of an animal;

FIG. 6 illustrates another exemplary respirator placed over the head of a user;

FIG. 7 illustrates an exemplary air source for use with the respirator shown in FIG. 6;

FIG. 8 illustrates another exemplary respirator placed over the head of a user;

FIG. 9 illustrates another exemplary respirator placed over the head of a user;

FIG. 10 illustrates folding or opening the exemplary respirator shown in FIGS. 6, 8 and 9;

FIG. 11 illustrates an exemplary device for storing the respirator shown in FIGS. 6, 8 and 9; and

FIG. 12 illustrates an exemplary storage device for the respirator shown in FIGS. 1a and 1b.

### DETAILED DESCRIPTION

The exemplary embodiments of the present application comprise various breathing apparatuses, referred to herein as respirators, that enable a user to breathe non-contaminated air or air that is at least less harmful to breathe than the contaminated air. Air can be contaminated by, for example, smoke, particulate matter, toxic gases, hydrogen cyanide, hydrogen chloride, carbon monoxide, biological weapons and chemical weapons. The exemplary respirators of the present application are operable to prevent or reduce inhalation of such contaminated air by a user. Further, the exemplary respirators prevent contaminated air from entering the nose, eyes and ears of the user. The exemplary respirators of the present application can be used by humans, both adults and children, and various animals, including dogs and cats.

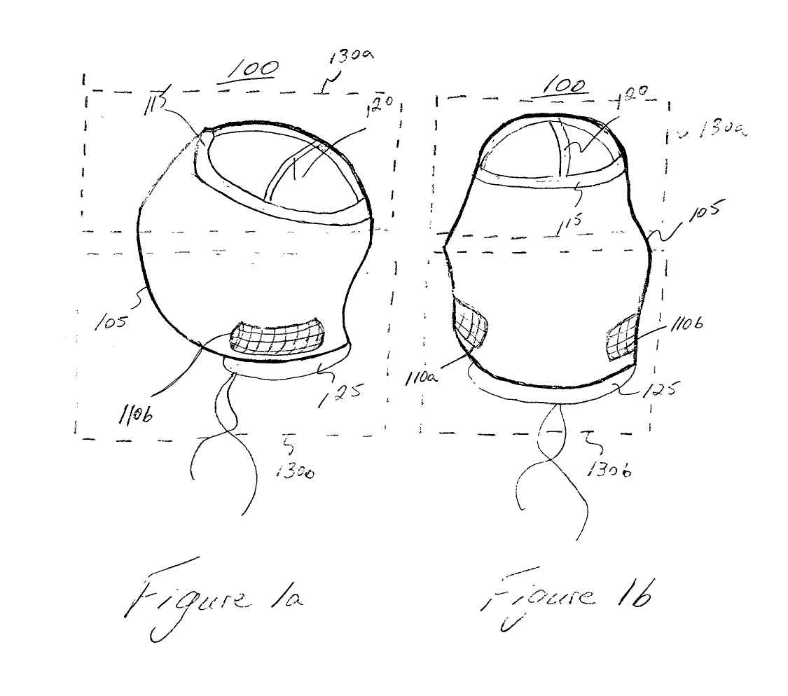

FIGS. 1a and 1b illustrate a side view and a front view, respectively, of exemplary respirator 100. Respirator 100 is operable as a hood that can be placed over the entire head of a user and sealed around the neck of the user. As will be described below, respirator 100 can placed on the head of a user with minimal or no concern whether respirator 100 is being used correctly due to the construction of respirator 100, for example, the transparency of bag 105 and the location of filters 110a, 100b.

Respirator 100 includes bag 105 having upper portion 130a and lower portion 130b, securing collar 125 attached to bag 105, band 115 attached to bag 105, crown device 120 attached to band 115 and/or bag 105 and at least one filter 110 attached to bag 105. As can be seen in FIGS. 1a and 1b, bag 105 covers crown device 120 and band 115 so that contaminated air cannot enter the inside of respirator 100 when located on the head of the user and secured around the user's neck. Alternatively, respirator 100 does not include crown device 120.

In an exemplary embodiment, bag 105 is made of a material that is transparent, lightweight, flexible, fire resistant, fog resistant and impermeable to air contaminated by, for example, smoke, particulate matter, toxic gases, hydrogen cyanide, hydrogen chloride, carbon monoxide, biological weapons and chemical weapons. An example of such material is a multi-layered copolymer, polyethylene material sold by Plastopil, Kibbutz Hazorea 30060, Israel. Other materials can obviously be used for bag 105. Bag 105 shown in FIGS. 1a and 1b is completely transparent. As a result of the entire bag 105 being transparent, the opening of bag 105 can be placed over a head without concern of whether a transparent portion is located in the proper place for visibility. In an alternative embodiment, however, only a portion of bag 105 is transparent so that user can only see out of that portion of bag 105 when in use. Bag 105 is not limited to any particular size or shape. Ideally, bag 105 has a size that is appropriate for numerous types of users, such as adults, children and different types of animals.

Since bag 105 is made of a lightweight and flexible material, bag 105 can easily conform to any head shape and size. Also, bag 105 prevents contaminated air from entering the nose, eyes and ears of the user, as bag 105 covers the entire head and is sealed around the neck of the user by securing collar 125.

Respirator 100 also includes filters 110a, 110b located in lower portion 130b of bag 105. More or less filters can obviously be incorporated into respirator 100 that are located in lower portion 130b and/or upper portion 130a. In an exemplary embodiment, filters 110a, 110b are preferably made of lightweight materials. Filters for filtering, for instance, smoke, particulate matter, toxic gases, hydrogen cyanide, hydrogen chloride, carbon monoxide, biological weapons and chemical weapons are well known in the art and are, thus, not described herein. If more or less types of contaminated air want to be filtered, the types of layers used for filters 110a, 100b can be changed accordingly. In addition, filters 110a, 110b are attached to bag 105 so as to be located away from a line of sight of the user when respirator 100 is placed over the head. For example, filters 110a, 110b are located in lower portion 130b of bag 105, as depicted in FIGS. 1a and 1b. As a result, when respirator 100 is located on the user's head, the user's eyes are not blocked, regardless whether the user is an adult, child or animal, and regardless of how the opening of bag 105 is placed on the head. Filters 110a, 110b can be placed in other locations as well and are not meant to be limited to the shapes and sizes shown in FIGS. 1a and 1b.

In operation, filters 110a, 110b enable a user to breathe non-contaminated air or air that is at least less harmful to breathe than the contaminated air. As described above, air can be contaminated by smoke, particulate matter, toxic gases, hydrogen cyanide, hydrogen chloride, carbon monoxide, biological weapons and chemical weapons. As is well known in the art, the usefulness of filters 110a, 110b depend upon the type of layers used and the type of contamination. When the user exhales, the exhaled air exits bag 105 through filters 110a, 110b. The location of filters 110a, 110b, however, does not compromise their utility to cause filtered contaminated air to flow into bag 105 and to cause exhaled air to exit bag 105. Preferably, filters 110a, 110b are located out of the line of sight of a user, regardless of the head size and shape of the user and regardless of the opening of bag 105 is placed over the head of the user.

Band 115 is attached to bag 105 in upper portion 130a. As a result, when respirator 100 is placed on a user's head, band 115 is located around the top of the head, preferably, around the user's forehead. Band 115 can encircle the entire head, as shown in FIGS. 1a and 1b, or only around a front portion of the head. Band 115 operable for securing bag 105 to the top of the head and for preventing 105 bag from rotating around the user's head after bag 105 is placed on the head. Band 115 can also be operable to create a distance between at least a portion of user's face and bag 105 so that bag 105 does not make contact with the user's face or little contact. For instance, bag 105 would make little contact with a user's face if band 115 horizontally extended out from the head of the user, like a brim of a hat. In an exemplary embodiment, band 115 is made of a lightweight and flexible material. For example, band 115 can be made of sponge, foam, plastic or elastic, or a combination thereof. Further, band 115 can be made of non-flexible material. Depending on the material of band 115, band 115 can also be operable to protect the user's head if the user's bumps into an animate or inanimate object.

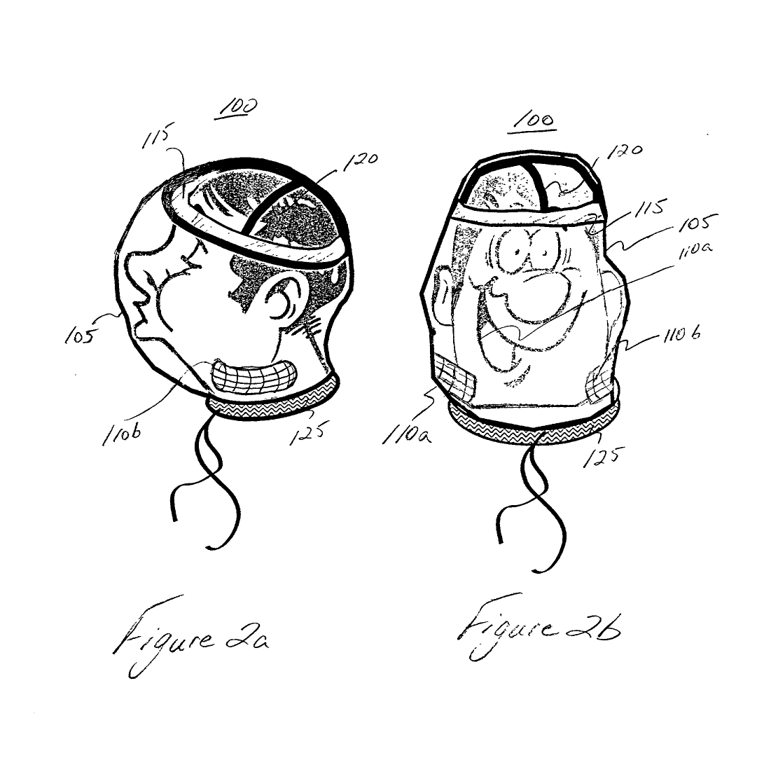

Respirator 100 also includes crown device 120 attached to band 115 and/or bag 105. Crown device 120 can prevent a user, or someone placing bag 105 over the head of a user, from puncturing bag 105 by pulling his, her or its head through the top of bag 105. In addition, crown device 120 is operable for respirator 100 to properly fit on the user's head, as shown in FIGS. 2a, 2b, 3, 4 and 5, when bag 105 is pulled down as much as possible. When properly fitted, band 115 lies on or near user's forehead. Crown device 120 can be configured as a cross bar, but is not limited to such a configuration. In an exemplary embodiment, crown device 120 or a portion thereof has a color which attracts attention of, for instance, a rescuer. Band 115 can also be colored. Such colors include red, orange or a fluorescent. As described above, bag 105 covers crown device 120 and band 115 to prevent contaminated air from entering bag 115 when securing collar 125 is sealed around the user's neck. As with band 115, crown device 120 fits on heads having varying shapes and sizes, such as a child's head, an adult's head and an animal's head, for example, by incorporating elastic material.

Crown device 120 and/or band 115 can be attached to bag 105 and band 115 does not need to be attached to crown device 120. Regardless of what is attached to bag 105, band 115 and crown device 120 remain in upper portion 130a of bag 105 so that when respirator 100 is removed from a storage unit band 115 and crown device 120 are properly located in bag 105. Further, respirator 100 can be devoid of crown device 120 without compromising respirator 100's functionality.

Once respirator 100 is placed on the head of the user, securing collar 125 attached to lower portion 130 of bag 105 is operable to seal the bottom of bag 105 around the user's neck. Securing collar 125 can be, for instance, elastic, a tying apparatus, one or more pull strings or Velcro, or a combination thereof. FIGS. 1a, 1b, 2a, 2b, 3, 4 and 5 illustrate an exemplary securing collar 125 as an elastic band with pull strings. By grabbing and pulling the pull strings, the user or someone else can tighten securing collar 125 around the neck to a desired comfort level. Alternatively, securing collar 125 automatically creates a seal around the user's neck without any manual intervention by the user or someone else, for instance, by incorporating elastic. Securing collar 125 is simple and quick to use regardless of the visibility at the time of use.

FIGS. 2a, 2b, 3, 4 and 5 depict various users utilizing the exemplary respirator 100 shown in FIGS. 1a and 1b. The present application, however, is not meant to be limited to users shown in the drawings. As can be seen in FIGS. 2a and 2b, when an adult places respirator 100 on his or her, band 115 rests on the user's forehead, crown device 120 rests on the crown of the user's head and securing collar 125 tightens around the user's neck. The user's eyes, ears and mouth are protected from the contaminate air by bag 100 and the user breathes the contaminated air through filters 110a, 110b. FIGS. 2a and 2b also depict filters 110a, 110b being out of the line of site of the user when respirator 100 is placed on the head of the user. In particular, filters 110a, 110b are located in lower portion 130b of bag 105. As a result, the user's head can be placed through the opening of bag 105 without concern of whether filters 110a, 110b are in the line of sight of the user and regardless of the visibility, for example, from smoke.

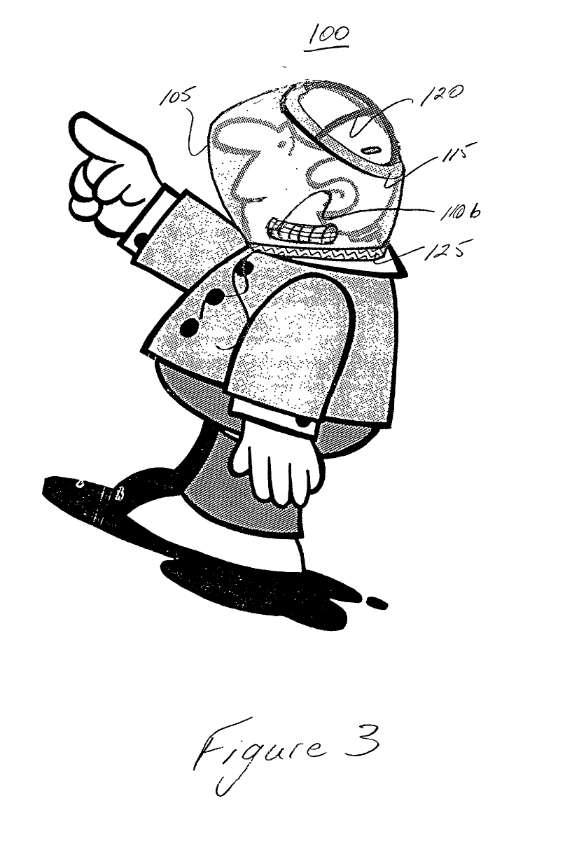

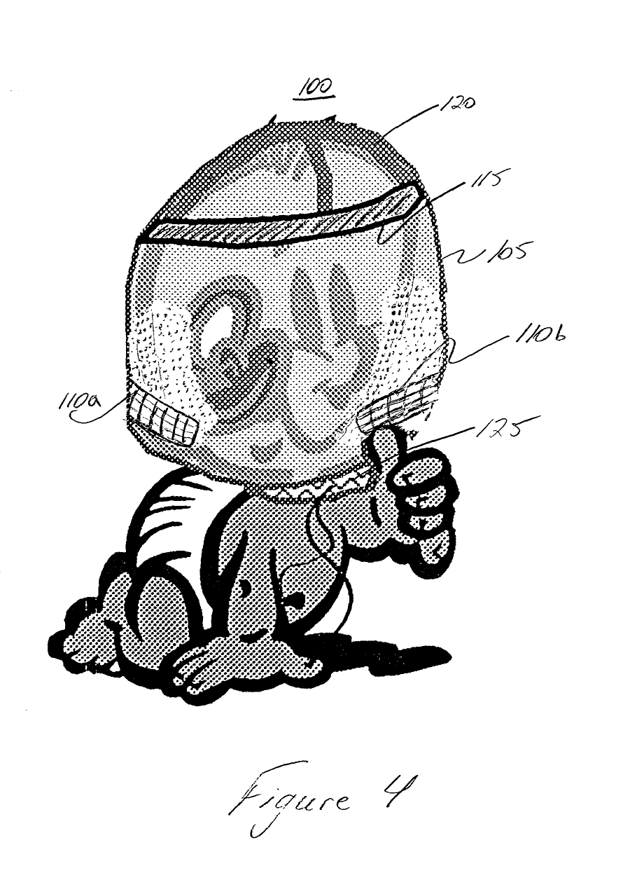

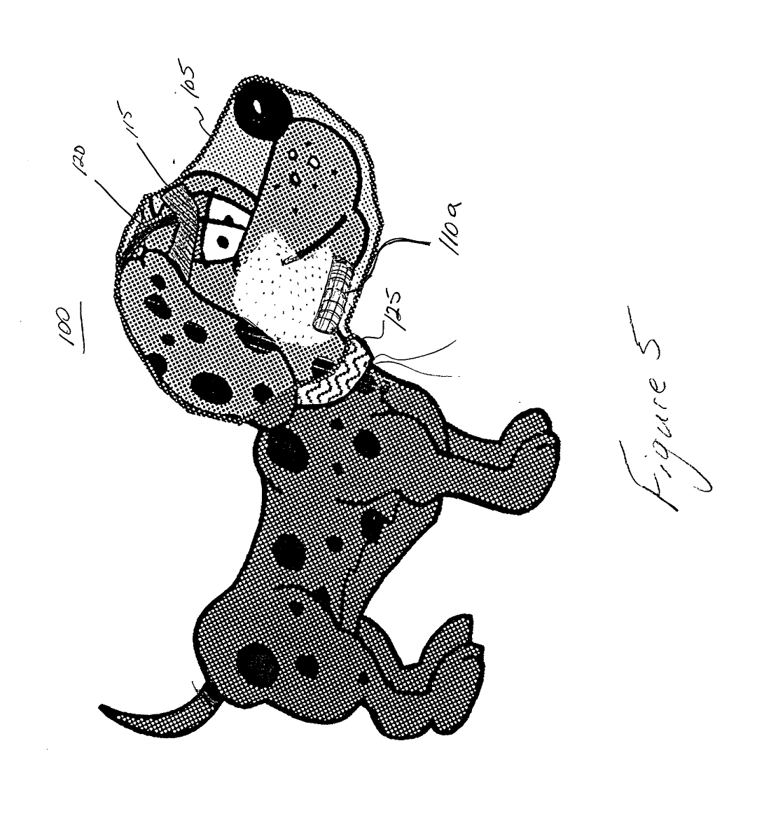

FIG. 3 illustrates respirator 100 placed over the head of another adult having a different head shape and size. Moreover, FIGS. 4 and 5 show respirator 100 placed over a child's head and the head of an animal, respectively. As with the adults shown in FIGS. 2a, 2b and 3, the eyes, ears and mouth of the child and of the animal are protected from the contaminated air. Band 115 rests on or near the foreheads of the child and animal and securing collar 125 tightens around their respective necks to seal the opening of bag 105.

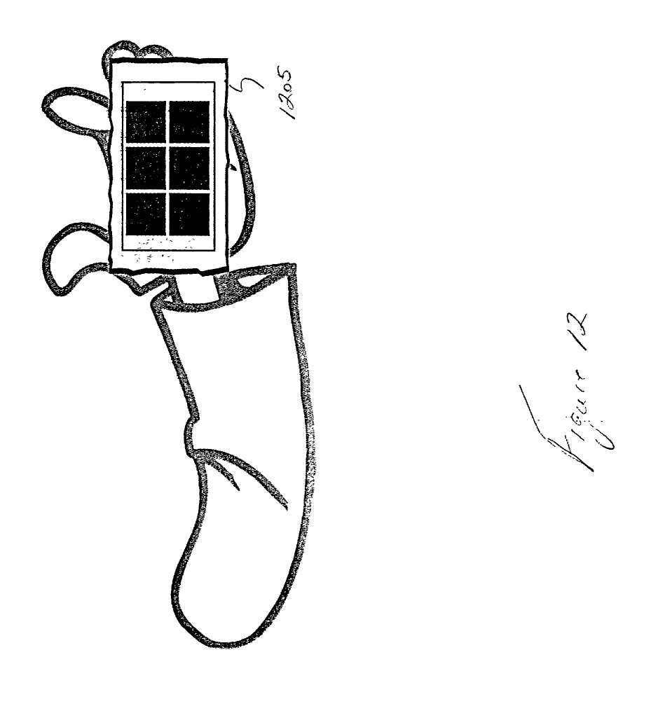

Respirator 100 described above can be stored, for instance, in a vacuum pack 1205 shown in FIG. 12. By storing respirator 100 in vacuum packing 1205, the user, or someone placing respirator 100 over the head of the user, can be assured that the respirator 100 has not been tampered with. In addition, vacuum pack 1205 protects filters 110a, 110b so that filters 110a, 110b are operable after extended storage periods. Other types of storage can also be used.

Respirator 100 provides a lightweight, flexible and safe mask that is simple and quick to properly place on the head of a user, regardless of the user's visibility and shape and size of the user's head. Also, respirator 100 is disposable, that is, the user discards respirator 100 after using it once. Alternatively, respirator 100 can be constructed for multiple uses, for example, by removably attaching filters 110a, 110b to bag 105 so that a user can change filters 110a, 110b.

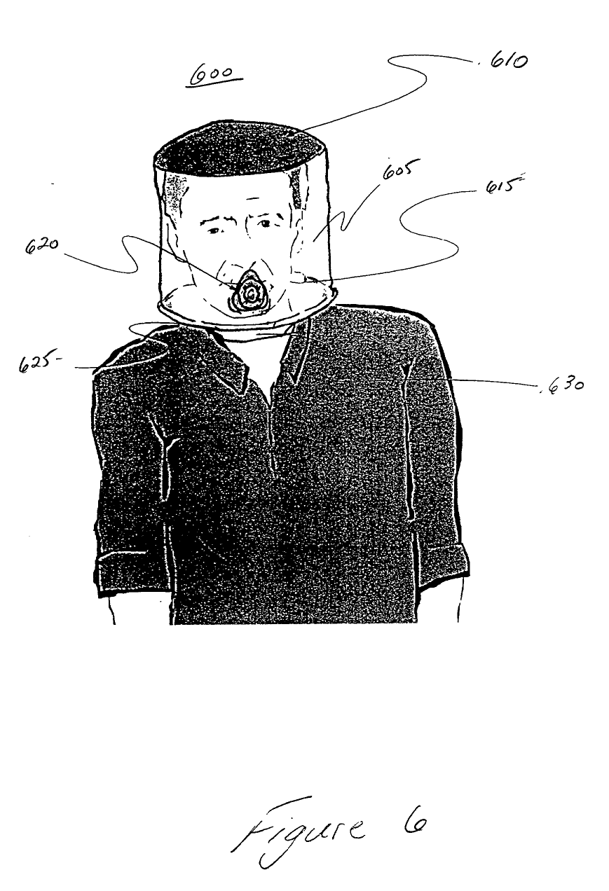

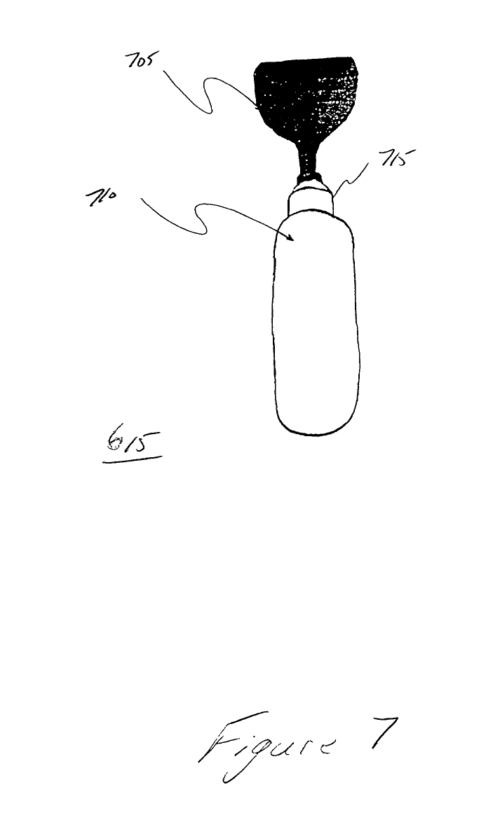

FIG. 6 illustrates exemplary respirator 600 placed over a head of a user. Respirator 600 includes bag 610 having an opening adapted to be placed over the head of a user and secured around the neck of the user by securing collar 630. Securing collar 630 can be, for example, elastic, a tying apparatus, one or pull strings or Velcro, or a combination thereof, for providing a tight fit around the user's neck. Bag 610 is not limited to having an opaque top as shown in FIG. 6, rather the top can be transparent. Bag 610 also includes outlet 620, and flexible ring 625 for keeping the shape of bag 605, as shown in FIG. 6 when placed over the head of the user. Air cavity 605 is located inside bag 610. Further, air source 615, for instance, an oxygen tank, is located inside or outside bag 605 for providing the air that the user breathes when bag 610 is placed over the user's head. FIG. 7 illustrates an exemplary oxygen tank 615. Oxygen tank 615 includes release device 705, oxygen storing unit 710 and oxygen outlet 715.

Bag 610, as well as bags 815 and 910, can be constructed of a variety of flexible and lightweight materials. For example, the materials can be the same as described above for bag 105 of respirator 100. At least a portion of bag 610 is constructed of a transparent material so that a user wearing bag 610 can see out. Bag 610 is not limited to any particular size, shape or color. Bag 610 can be constructed so that bag 610 can fit over any user's head regardless of age, hairstyle or the use of eyeglasses. Further, bag 610, as well as bags 815, 910, can be put on an animal's head. Alternatively, different bags can be constructed to fit different types of users. In an exemplary embodiment, bag 610 surrounds the head of a user with minimal or no contact with the head due to the flexible ring 625. As can be seen in FIG. 6, bag 610 covers the user's eyes, ears and mouth.

When the user places bag 610 over his or her head, release device 705 automatically disengages from oxygen outlet 715 and causes oxygen stored in oxygen storing unit 710 to flow through oxygen outlet 715 and into cavity 605. Alternatively, release device 705 can be punctured or broken apart to enable oxygen to flow through oxygen outlet 715. Release device 705 automatically disengages from outlet 715 due to flexible ring 625 snapping open and making contact with at least a portion of release device 705. Release device 705 and flexible ring 625 can be configured in a number of ways so that oxygen automatically flows from oxygen outlet 715 soon after respirator 600 is removed from a storage unit, such as a vacuum packed storage unit. As a result, cavity 605 already contains oxygen from oxygen storing unit 710 when a user places respirator 600 over his or her head. Oxygen flows through outlet 715 at a rate that can be uniform over time or vary according to predetermined criteria. The user breathes the oxygen through the user's nose and exhales carbon dioxide which escapes cavity 605 through outlet 620. The individual's mouth does not need to be in contact with outlet 620 and outlet 620 can be located any where on bag 610, for example, on the side or back of bag 610. Preferably, outlet 620 is located in a lower portion of bag 610 so that the user's line of sight is not obstructed regardless of how respirator 600 is placed on the user's head. In an exemplary embodiment, outlet 620 releases a mixture of oxygen and carbon dioxide or, alternatively, outlet 620 releases only carbon dioxide from cavity 605. Some carbon dioxide may remain in cavity 605. In an alternative embodiment, the user's mouth is affixed to outlet 620 to enable the carbon dioxide to be released from cavity 605.

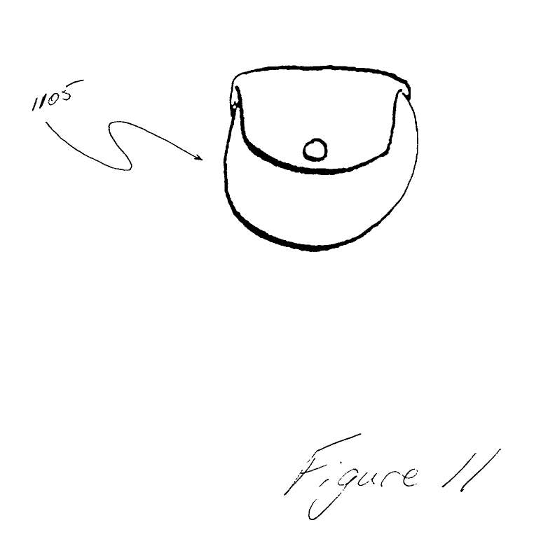

In an alternative embodiment, securing collar 630 does not provide an airtight fit around the neck of the individual. However, due to cavity 605 having a greater atmospheric pressure than the air outside bag 610, potentially contaminated air from outside bag 610 does not enter cavity 605. In addition, upon removing respirator 600 from storage, such as from storage unit 1105 shown in FIG. 11, flexible ring 625 having a spring-like resiliency causes at least a lower portion of bag 610 to achieve the form shown in FIG. 6. As a result of the assumed shape, bag 610 does not make contact with the user's face or makes little contact. Flexible ring 625 also enables respirator 600 to be easily reinserted into a storage unit, for example, storage unit 1105, as depicted in FIG. 11. and described in more detail below.

Each of the exemplary breathing apparatuses described in the present application that use an air source can be stored in a vacuum sealed bag in order to notify a potential user that some air has leaked from the source during storage. Specifically, the bag or a portion thereof will expand due to the leaking air and as a result put the user or another person on notice that some, if not all, of the air has leaked. Other leaking indicators can be used besides viewing the expansion of a storage bag, such as a change in coloration of the bag or a portion thereof.

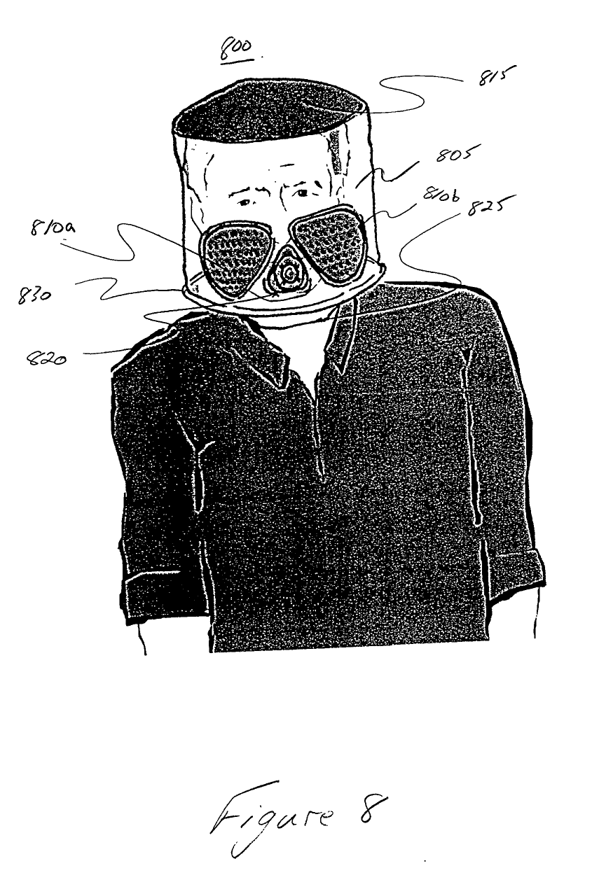

FIG. 8 illustrates an additional exemplary respirator 800 placed over a head of a user. Respirator 800 includes bag 815 adapted to be placed over the head of the user and secured around the neck of the user by securing collar 825 to create a tight fit around the neck. Bag 815 includes inlets 810a, 810b, outlet 820 and flexible ring 830. More or less inlets can be used. As with outlet 620, outlet 820 and inlets 810a, 810b are attached to bag 815 so that they are not in the line of sight of the user. Preferably, outlet 820 and inlets 810a, 810b are located in a lower portion of bag 815 so that is does not matter how respirator 800 is placed on the head of the user. Air cavity 805 is located inside bag 815. Bag 815 and securing collar 825 are similar to bag 610 and securing collar 630 and are, therefore, not described again with reference to FIG. 8. Likewise, flexible ring 830 operates as described above with reference to FIGS. 6 and 7.

As with respirator 600, a user first places the opening of breathing respirator 800 over his or her head and manually secures securing collar 825 around the neck, for example, by grabbing pull ties or using a Velcro strap. Alternatively, securing collars 825, and securing collars 630 and 930, can be constructed so that the respective securing collar tightly fits around a neck without any manual intervention by the user, for example, by utilizing elastic.

Inlets 810a, 810b include at least one filter for filtering contaminated air. The choice of which filter(s) and filtering layers to include in inlets 810a, 810b depends on what types of contaminated air are desirable to purify. The same filters as described above with reference to FIGS. 1a and 1b can be used. As a result of the filtering process, the user breathes non-contaminated air or less contaminated air in cavity 805. Outlet 820 is operable to allow exhaled carbon dioxide to exit cavity 805. Outlet 820 is the same as outlet 620 described above with reference to FIG. 6.

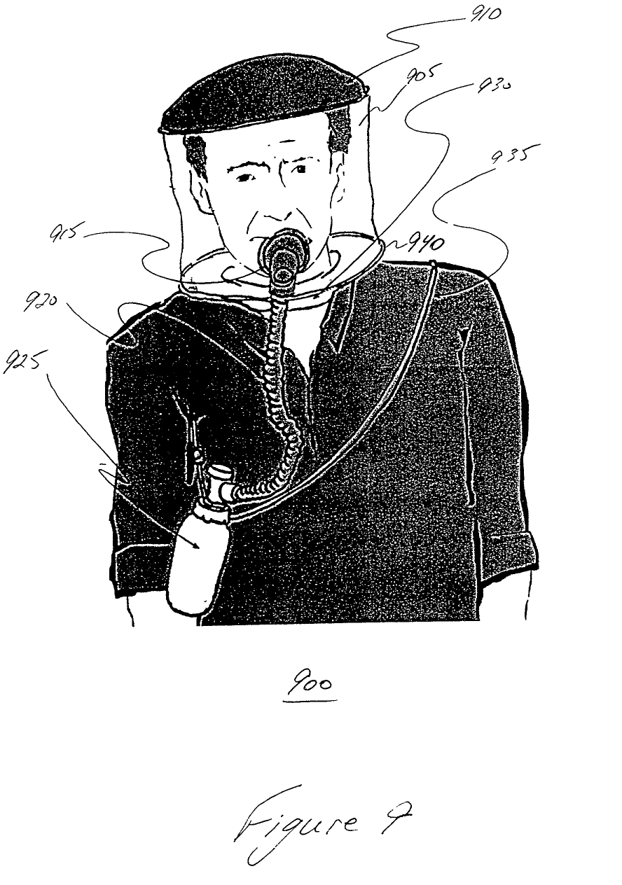

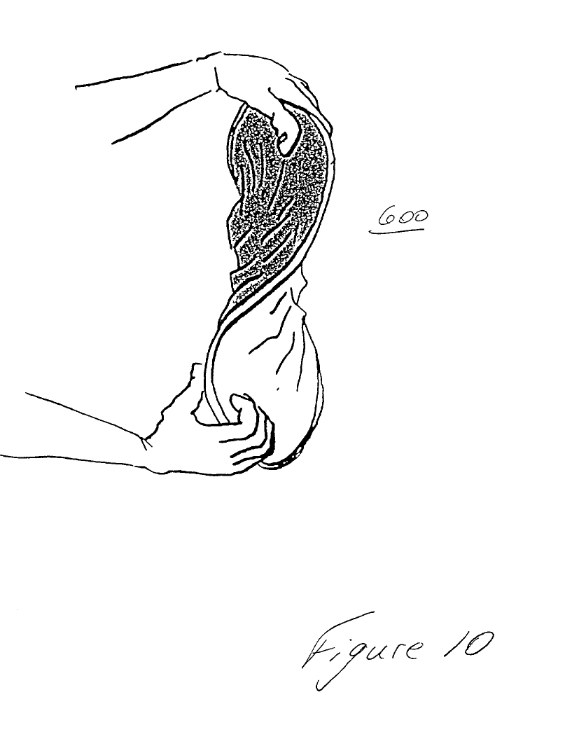

A still further exemplary respirator 900 is illustrated in FIG. 9. Respirator 900 includes oxygen tank 925 affixed to the user, for example, by strap 935. Oxygen tank 925 is operable to provide oxygen to the user through flexible hose 920 and inlet/outlet 915. The user inhales the oxygen existing in cavity 905 and exhales carbon dioxide which exits cavity 905 through inlet/outlet 915. The carbon dioxide can exit cavity 905 in a similar manner as explained above with reference to FIGS. 6 and 8. Bag 910, securing collar 930 and flexible ring 940 are the same as bag 610, securing collar 630 and flexible ring 625 and are not again explained with reference to this exemplary embodiment.

The embodiments described above are illustrative examples of the present invention and it should not be construed that the present invention is limited to these particular embodiments. Various changes and modifications may be effected by one skilled in the art without departing from the spirit or scope of the invention as defined in the appended claims. Accordingly, the present invention is not limited except as by the appended claims.

I claim:

1. An inhalation protection apparatus, comprising:
a transparent bag made of a lightweight and flexible material for covering a head of a user, the transparent bag including a lower portion having an opening and an upper portion;
at least one filter for filtering air outside the transparent bag, the at least one filter attached to the transparent bag and located away from a line of sight of the user; and
a band attached to the upper portion of the transparent bag for encircling the head, the band operable for making contact with the head and for securing the transparent bag to the top of the head and preventing the transparent bag from rotating around the head of the user after the transparent bag is placed on the head, wherein
the opening of the transparent bag can be placed over the head in any manner as a result of the bag being made of a transparent material and the at least one filter being located away from the line of sight of the user.

2. The inhalation protection apparatus as set forth in claim 1, further comprising:
a securing collar attached to the transparent bag, the securing collar operable to tighten the lower portion of the transparent bag around the neck of the user.

3. The inhalation protection apparatus as set forth in claim 2, wherein
the securing collar includes elastic.

4. The inhalation protection apparatus as set forth in claim 2, wherein
the securing collar includes a pull string.

5. The inhalation protection apparatus as set forth in claim 2, wherein
the securing collar includes Velcro.6. The inhalation protection apparatus as set forth in claim 1, further comprising:
a cross bar attached to the band, the cross bar resting on the top of the head.

6. The inhalation protection apparatus as set forth in claim 1, wherein
the at least one filter is located in the lower portion of the bag and the upper portion of the bag.

7. The inhalation protection apparatus as set forth in claim 1, wherein
the transparent bag is made of a fire resistant material.

8. The inhalation protection apparatus as set forth in claim 1, wherein
the user is a human.

9. The inhalation protection apparatus as set forth in claim 1, wherein
the user is an animal.

10. The inhalation protection apparatus as set forth in claim 8, wherein
the human is a child.

11. A respirator, comprising:
a transparent bag made of a lightweight and flexible material for covering a head of a user, the transparent bag including a lower portion having an opening and an upper portion;
at least one filter for filtering contaminated air outside the transparent bag, the at least one filter attached to the transparent bag and located in the lower portion of the transparent bag so that the at least one filter is located away from a line of sight of the user;
a band attached to the upper portion of the transparent bag for encircling the head, the band operable for making contact with the head and for securing the transparent bag to the top of the head by resting on the forehead; and
a securing collar attached to the transparent bag, the securing collar operable to tighten the lower portion of the transparent bag around the neck of the user, wherein
the user can be an adult, a child or an animal, and
the opening of the transparent bag can be placed over the head in any manner as a result of the bag being made of a transparent material and the at least one filter being located away from the line of sight of the user.
